(19) United States
(12) Patent Application Publication
(10) Pub. No.: US 2006/0274080 A1
(43) Pub. Date: Dec. 7, 2006

(54) Texture cache memory device, 3-dimentional graphic accelerator using the same and method thereof

(75) Inventors: Kil-Whan Lee, Seoul (KR); Young-Jin Chung, Gyeonggi-do (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/430,434

(22) Filed: May 9, 2006

(30) Foreign Application Priority Data
May 18, 2005 (KR) 2005-41640

(51) Int. Cl. G09G 5/00

(52) U.S. Cl. 345/582

(57) ABSTRACT

Disclosed is a texture cache memory device in which the size of an active field in a cache unit changes along the number of the textures to be mapped on an abject. If the required number of the textures is small, a hit rate is maintained even with a smaller size of the active field, reducing power consumption therein. If the required number of the textures is large, the size of the active field is enlarged to enhance the hit rate even in higher power consumption, decreasing loading weight while accessing a main memory. Thus, the texture cache memory device is operable with the optimum condition in accordance with the number of the textures.

### CROSS-REFERENCE TO RELATED APPLICATIONS

This U.S. non-provisional patent application claims priority under 35 U.S.C. §119 of Korean Patent Application 2005-41640 filed on May 18, 2005, the entire contents of which are hereby incorporated by reference.

### BACKGROUND

The subject matter disclosed herein is concerned with 3-dimensional graphic processing technologies. In particular, the subject matter disclosed herein relates to texture cache memory devices for use in 3-dimensional graphic accelerators.

3-dimensional graphic technologies are used to depict 3-dimensional objects in height, width, and length and then display the solid images realistically on 2-dimentional screens. 3-dimensional graphic accelerators are apparatuses for generating images as outputs with adopting parameters such as timing points or illuminations from receiving geometrical patterns illustrated by figure modelers.

A procedure carried out by a 3-dimensional graphic accelerator is usually referred to as graphics pipeline. In the sequence of the graphics pipeline, if there is a late portion through time at least, it is inevitable for the overall pipelining process to be delayed thereby. The graphics pipelining operation may be divisionally processed with geometry and rendering sections. A calculation amount in the geometry process is proportional to the number of polygonal apexes counted therein. In the rendering process, a calculation amount thereof is proportional to the number of pixels generated therein.

In a graphic process on a high-resolution monitor, it needs to raise an operation speed of a rendering engine along an increase of the number of pixels. In order to overcome such requirement in speed for the rendering process, there are several ways of improving an internal architecture of the rendering engine or parallelizing a processing mode thereof by increasing the number of rendering engines.

The most important matter in raising a processing speed (or frequency) of the rendering engine is reducing a bandwidth of the memory. In displaying a 3-dimensional object on a 2-dimensional screen, it is required of processing texture and pixel data those are stored in the memory. In order to reduce times and burdens in accessing the memory, it is essential to design the graphic accelerator to include a cache memory therein.

Recent 3-dimensional graphic applications utilize the way of mapping various textures onto an object in purpose of obtaining more natural and smooth images and generating specific effects while rendering a 3-dimensional scene in real time, which is called “multi-texturing”. During this, the performance of the 3-dimensional graphic accelerator is dependent on how fast a texture is fetched from a texture memory (a main memory or an graphic-exclusive memory located out of the 3-dimensional graphic accelerator) and put into the texture mapping process. While it is required of retrieving texel from the memory each by each so as to use a multiplicity of texture, the cache memory is variably featured with hit rate and power consumption in accordance with the organization thereof.

For instance, when the texture cache memory is structured of direct-mapping organization, there is increased a frequency of generating conflict-miss during the procedure of mapping a plurality of textures. This is because the plurality of textures are positioned in various address spaces of the texture cache memory.

While it is able to raise the hit rate of the texture cache memory by configuring the texture cache memory into multi-way set-associative mapping association, there is a problem of increasing power consumption during a comparing operation with tags. In general, the rate of power consumption increases in proportion with the number of ways.

Further, as the plurality of textures to be mapped onto an object is not usually fixed to every 3-dimensional application, it is difficult to overcome the problems of hit rate and power consumption by optionally setting the number of ways in the cache memory.

### SUMMARY OF THE INVENTION

Some embodiments of the invention are directed to a texture cache memory device that may be configured with optimum memory organization for a multi-texturing environment.

Some embodiments of the invention provide a 3-dimensional graphic accelerator that includes a texture cache memory device which may have an optimum memory organization for a multi-texturing environment.

Some embodiments of the invention are directed to a texture cache memory device minimizing an increase of power consumption while improving a hit rate in multi-texturing environment.

Some embodiments of the invention may provide a 3-dimensional graphic accelerator that includes a texture cache memory device that may minimize an increase of power consumption while improving a hit rate in multi-texturing environment.

Some embodiments of the invention may provide a method of operating the texture cache memory device for 3-dimensional graphic data.

In some embodiments of the invention, a method of operating a texture cache memory device includes the steps of inputting information of the number of textures, and determining a size of an active field of the texture cache memory device in accordance with the number of the textures.

In a further embodiment, the step of determining the size of the active field comprises: determining a bit width of the set in an address signal in accordance with the determined size of the active field.

In a further embodiment, the method further comprises: inputting the address signal; and enabling the active field of the texture cache memory device with reference to a bit value of the set in the address signal.

In a further embodiment, the texture cache memory device includes N regions and the step of determining the size of the active field comprises establishing N/k (k≦N) regions, among the N regions of the texture cache memory device, as the active field.

In a further embodiment, the textures are mapped on an object.

According to another aspect of the invention, a method of operating an N-way texture cache memory device comprises the steps of: inputting information of the number of textures; and selecting N/k (k≦N) ways as an active field with reference to the number of the textures.

In a further embodiment, the method further comprises: determining a bit width of a set in an address signal in accordance with the number of the selected ways; inputting the address signal; and enabling the active field of the texture cache memory device with reference to a bit value of the set in the address signal.

In a further embodiment, the number of the textures is proportional to the number of the ways selected into the active field.

In a further embodiment, the method further comprises: inactivating N-N/k ways of the texture cache memory device with reference to the bit value of the set in the address signal.

In a further embodiment, the texture cache memory device includes an N-way tag memory storing a tag address and an N-way data memory storing data, and the step of selection comprises assigning N/k ways among N ways of the tag memory and N/k ways among N ways of the data memory to the active field.

In a further embodiment, the method further comprises: comparing a tag of the address signal with tags stored in the N/k ways of the tag memory which are assigned to the active field.

In a further embodiment, the texture cache memory device further includes N comparators each corresponding to N ways of the tag memory, comparing a tag of the address signal with tags stored in corresponding ways of the tag memory, in which the method of the invention which further comprises: activating N/k comparators, among the comparators, corresponding to the N/k ways of the tag memory which are assigned to the active field, in accordance with the number of the textures.

In a further embodiment, the method further comprises: inactivating the rest comparators except the N/k comparators selected in the comparators.

In still other embodiments of the invention, a texture cache memory device comprises: a texture cache memory storing textures; and a control logic receiving information of the number of textures and selecting a size of an active field in accordance with the number of the textures.

In a further embodiment, the control logic receives an address signal and selects the active field of the texture cache memory in response to the address signal and the selected size.

In a further embodiment, the texture cache memory includes N regions.

In a further embodiment, the control logic assigns N/k regions (k≦N) among the N regions to the active field.

In another embodiment of the invention, a texture cache memory device includes: a tag memory storing tags; a data memory storing texture data; N comparators corresponding to ways of the tag memory; and a control logic activating N/k (k≦N) comparators among the N comparators in response to the number of textures and an address signal.

In a further embodiment, the address signal includes tag and set.

In a further embodiment, the control logic determines a bit width of the set in the address signal in accordance with the number of the textures and activates the N/k (k≦N) comparators among the N comparators in accordance with a bit value of the set in the address signal. Each of the N/k (k≦N) comparators activated the N comparators makes a comparison between the tag of the address signal and a tag correspondingly stored in the tag memory. During this, N-N/k comparators among the N comparators are inactivated.

Some embodiments of the invention also provide a 3-dimensional graphic accelerator comprising: a texture cache memory device storing texture data, the texture cache memory device being comprised of: a tag memory storing tags; a data memory storing texture data; N comparators corresponding to ways of the tag memory; and a control logic activating N/k (k≦N) comparators among the N comparators in response to the number of textures and an address signal.

### BRIEF DESCRIPTION OF THE FIGURES

Non-limiting and non-exhaustive embodiments of the present invention will be described with reference to the following figures, wherein like reference numerals refer to like parts throughout the various figures unless otherwise specified.

FIG. 1 is a block diagram illustrating a digital signal processing system including 3-dimentional graphic accelerator in accordance with a preferred embodiment of the invention;

FIG. 2 is a block diagram illustrating a detailed structure of a texture cache memory device in accordance with a preferred embodiment of the invention;

FIGS. 3 through 6 are schematic diagrams illustrating operations of the texture cache memory device in accordance with a preferred embodiment of the invention, depicting the cases that the numbers of the textures input thereto are A, B, C, and D, respectively; and

FIG. 7 is a flow chart showing an operational procedure of the texture cache memory device in accordance with a preferred embodiment of the invention.

### DETAILED DESCRIPTION OF PREFERRED EMBODIMENTS

Preferred embodiments of the invention will be described below in more detail with reference to the accompanying drawings. The invention may, however, be embodied in different forms and should not be constructed as limited to the embodiments set forth herein. Rather, these embodiments are provided so that this disclosure will be thorough and complete, and will fully convey the scope of the invention to those skilled in the art.

Hereinafter, it will be described about an exemplary embodiment of the invention in conjunction with the accompanying drawings.

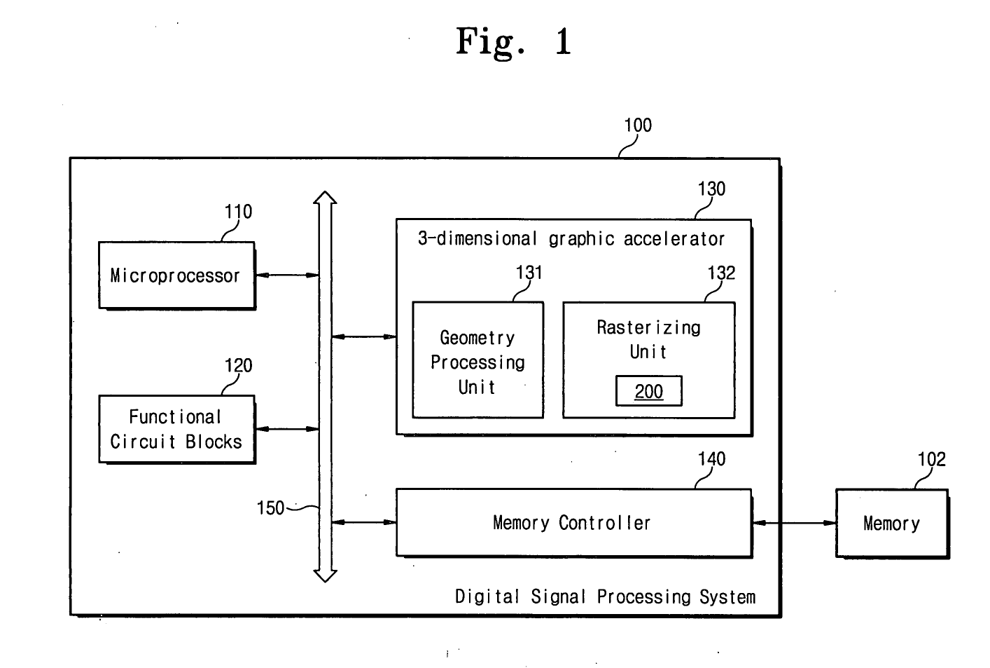

FIG. 1 is a block diagram illustrating a digital signal processing system including 3-dimentional graphic accelerator in accordance with a preferred embodiment of the invention.

Referring to FIG. 1, the digital signal processing system 100 is comprised of a microprocessor 110, functional circuit blocks 120, a 3-dimensional graphic accelerator 130, and a memory controller 140.

The digital signal processing system 100 is embedded in a digital electronic apparatus such as a personal computer, a portable computer, a mobile phone, or a personal digital assistant (PDA). The digital signal processing system 100 according to the preferred embodiment of the invention may be mounted on a portable electronic apparatus such as a mobile phone or a PDA, being fabricated in the form of system-on-chip (SOC).

The microprocessor 110 is a kind of main processor such as a central processing unit (CPU). The functional circuit blocks 120 include an input/output control circuit, a motion-picture-expert-group (MPEG) processor, and so forth. The memory controller 140 is interposed between an external memory 102 and a bus 150. The external memory 102 is a main memory of the system or a graphic-exclusive memory. In this embodied specification, the external memory 102 is used for storing texture data.

The 3-dimensional graphic accelerator 130 is comprised of a geometry processing unit 131 and a rasterizing unit 132. The 3-dimensional graphic accelerator 130 may further include other components such as an edge-walk processing unit in addition to the units 131 and 132 as shown in the Figures. Especially, the rasterizing unit 132 is comprised of a texture cache memory device 200 according to the preferred embodiment of the invention.

The 3-dimensional graphic accelerator 130 generates image data to be displayed, after prosecuting hardware acceleration for 3-dimensionl data in real time. The 3-dimensional graphic accelerator 130 conducts the geometry and rendering processes by classification in rough. The geometry process is carried out to transform an object of the 3-dimensional coordinates into image data according to visual points and then to reflect the transformed image data on the 2-dimensional coordinates. The rendering process is conducted to determine colors of the image data displayed on the 2-dimensional coordinates.

A 3-dimensional graphic image is almost constituted of points, lines, and polygons. The geometry processing unit 131 transforms an object of the 3-dimensional coordinates into images by visual points and then casts reflections of the images to the 2-dimensional coordinates. The rasterizing unit 132 generates texel by filtering textures read out from the memory 102 and outputs final data, which is to be displayed, by mixing the texel with pixel data of the geometry processing unit 132. The rasterizing unit 132 is comprised of the texture cache memory device 200 so as to reduce a frequency of accessing the memory 102.

The texture cache memory device 200 is storing a part of texture data to be stored in the memory 102. When the rasterizing unit 132 is being required of reading texture data from the memory 102, it determines whether the texture data is staying in the texture cache memory device 200. If the texture data is being stored in the texture cache memory device 200, it is read out from the texture cache memory device 200. Unless the texture data is being stored in the texture cache memory device 200, a block corresponding to the texture data is read out from the memory 102, stored in the texture cache memory device 200, and then transferred to the rasterizing unit 132. The block read out from the memory 102 is composed with a plurality of texture data. Considering the locality of reference that the same positions in the memory or other positions in the block are referred to the texture data again, the block of the texture data is read out from the memory 102 and stored into the texture cache memory device 200.

The rasterizing unit 132 in the 3-dimensional graphic accelerator 130 according to the preferred embodiment of the invention provides the texture cache memory device 200 with the number of the textures necessary for generating a texel. The texture cache memory device 200 may be partially or wholly activated, in which a size of the active field is established in accordance with the number of the textures input thereto.

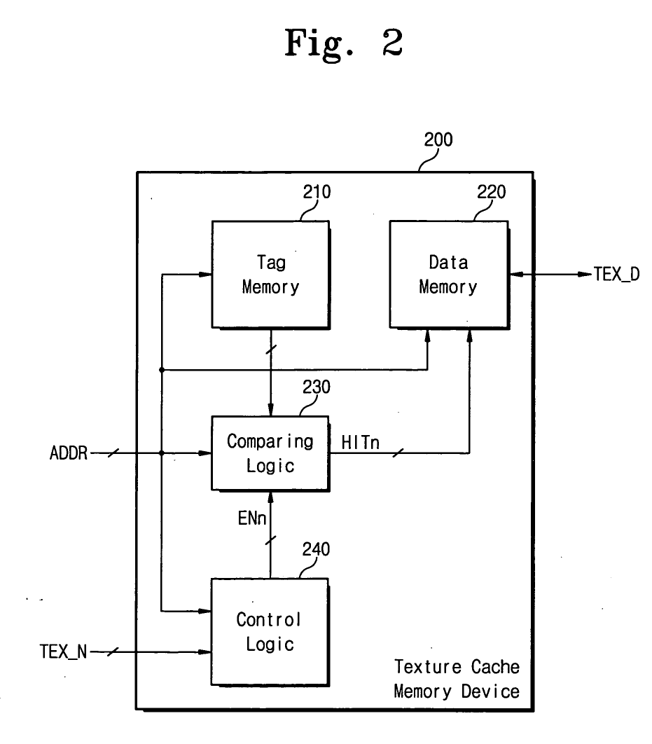

FIG. 2 illustrates a detailed functional structure of the texture cache memory device 200 in accordance with the preferred embodiment of the invention. Referring to FIG. 2, the texture cache memory device 200 is comprised of a tag address memory 210 storing tag addresses, a data memory 220 storing texture data, a comparing logic 230, and a control logic 240.

In the preferred embodiment, the tag memory 210 and the data memory 220 are constructed in N-way set-associative organization. An address signal ADDR includes tag, set, and offset addresses. Each way of the tag memory 210 and the data memory 220 includes pluralities of lines. The offset address is provided to access lines of each way.

The comparing logic 230 compares tag addresses of the tag memory 210 with the tag address of the address signal ADDR input from the rasterizing unit 132. If there is an agreement between the tag addresses, a hit signal HIT is activated in correspondence with the tag address. The data memory 220 provides a texture data TEX_D for the rasterizing unit 132 in correspondence with the hit signal HIT.

The control logic 240 according to a preferred embodiment of the invention sets the sizes of the active fields of the tag memory 210, the data memory 220, and the comparing logic 230 in response to the number of textures, TEX_N, provided from the rasterizing unit 132. The size of the active field is dependent on a bit width of the set in the address signal ADDR input from the rasterizing unit 132.

In addition, the control logic 240 according to a preferred embodiment of the invention generates an enabling signal EN to activate the active fields of the tag memory 210, the data memory 220, and the comparing logic 230 in response to a bit value of the set in the address signal ADDR input from the rasterizing unit 132.

As aforementioned, while it is helpful for raising a cache hit rate to configure the texture cache memory in the multi-way set-associative mapping organization under the multi-texturing environment, there is shortness of increasing power consumption therein. And, as the number of the textures to be mapped onto an object is not usually fixed to every 3-dimensional application, it is difficult to overcome the problems of hit rate and power consumption by optionally setting the number of ways in the cache memory.

For example, the tag and data memories, 210 and 220, are composed in the N-way set-associative organization, while the comparing logic 230 includes comparators each corresponding to the N ways of the tag memory 210. With these conditions, the control logic 240 activates N/k (k≦N) ways of the tag and data memories 210 and 220 in accordance with the number of the textures input from the rasterizing unit 132, and activates the comparators of the comparing logic 230 in correspondence with the activated ways of the tag memory 210.

As such, if there are activations just in the N/k ways of the tag and data memories 210 and 220 and in the N/k comparators of the comparing unit 230, the texture cache memory device 200 acts as an N/k-way cache memory device. The number of the textures in need is proportional to the number of ways to be active. In other words, if there is increased the number of the textures mapped on an object, the number of ways activated in the texture cache memory device 200 rises to improve the hit rate. Otherwise, if the number of the textures in use becomes smaller, the number of ways activated in the cache memory device 200 decreases to reduce power consumption therein.

In the case that the tag and data memories 210 and 220 are constructed of registers, it is possible to activate/inactivate each way, as a method for interrupting a clock signal input to each way. On the other hand, if the tag memory 210 includes a memory cell array such as content addressable memory (CAM) cells while the data memory 220 is composed of a static ransom-access memory (SRAM), it difficult to partially activate the memories. In this case, the partial activation is not applied to the tag and data memories 210 and 220 but to the comparing logic 230 in accordance with the number of the textures, so that it is able to operate the memory system as like that the tag and data memories 210 and 220 are conductive only with N/k ways therein. This control feature reduces the power consumption only in the comparing logic.

A direct or fully-associative mapping scheme is operable with a higher hit rate than other organizations, but much power consumption. Comparatively, the multi-way set-associative mapping scheme has a lower hit rate and a smaller power consumption, than the direct or fully-associative mapping scheme, as smaller the number of ways is.

Therefore, the texture cache memory device 200 of the invention is able to provide the optimum environment for operation that is proper all to the hit rate and power consumption because the number of ways activated is variable thereby in accordance with the number of the textures.

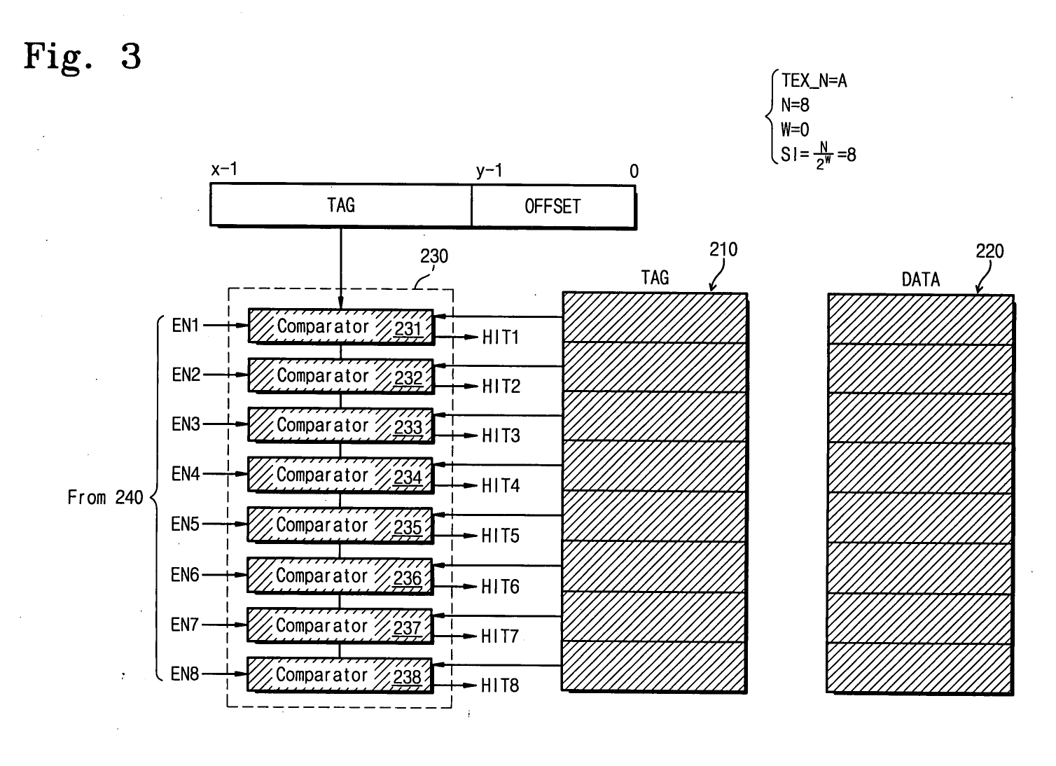

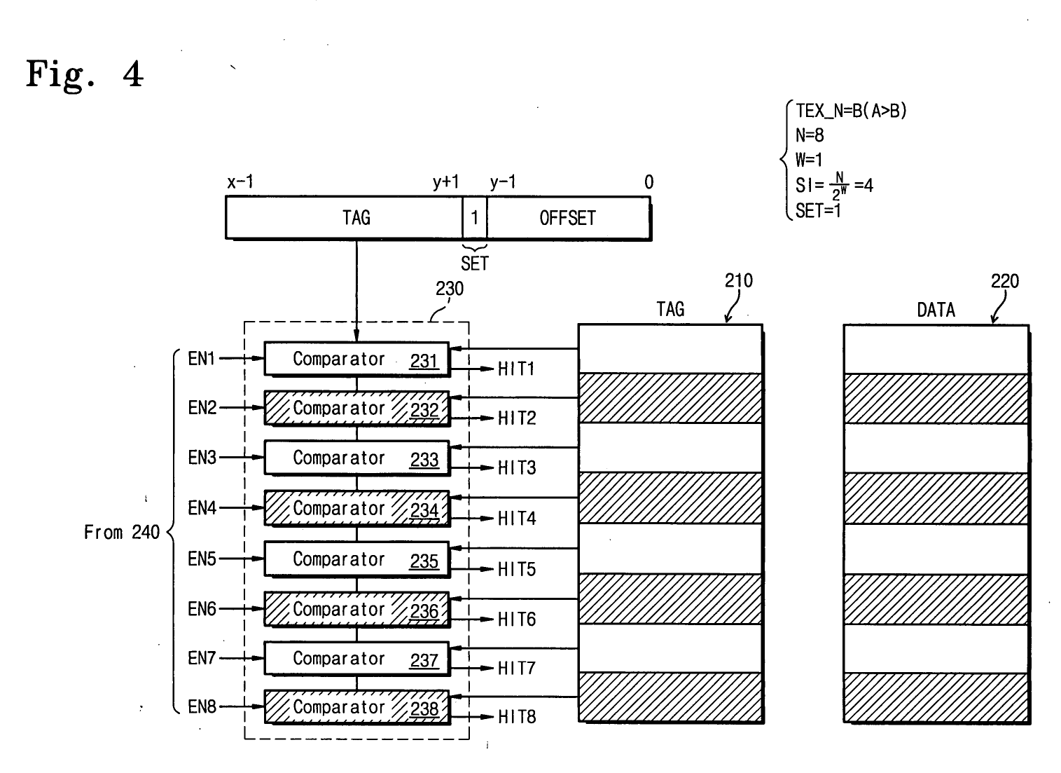

FIGS. 3 through 6 are schematic diagrams illustrating operations of the texture cache memory device 200 in accordance with a preferred embodiment of the invention, depicting the cases that the numbers of the textures, TEX_N, input thereto, are A, B, C, and D, respectively. Here, A>B>C>D. And, the maximum number of ways, N, in the tag memory 210 and the data memory 220 is 8. While specific numeric values are limited on the way number N, the bit width of the set W, the active field size SI, the bit value SET of the set, and the number of textures TEX_N in this specification according to the embodiment of the invention, these values are variable by those skilled in the art with regarding operational conditions. In FIGS. 3 and 4, the hatched regions denote the active fields.

FIG. 3 illustrates active fields of the texture cache memory device 200 when the texture number input thereto is A. The comparing logic 230 is composed of 8 comparators 231˜238 each corresponding to the ways of the tag and data memories 210 and 220. The comparators 231˜238 are activated in response each to a corresponding one among the enabling signals ENn that are provided from the control logic 240 shown in FIG. 2. Here, n=1, 2, . . . , N. Each of the activated comparators makes a comparison between a tag of the memory address and a tag stored in a corresponding way of the tag memory 210. If there is an agreement between the tags, the comparator corresponding thereto activates the hit signal HIT. The hit signals HITn from the comparators 231˜238 are applied to the data memory 220.

When the number of the textures is set on the maximum value A, the texture cache memory device 200 operates in fully associative organization, i.e., acting as an N-way cache. In other words, when the memory address is composed of x bits and the offset address is composed of y bits, the tag address is formed of x-y bits. Thus, the tag and data memories 210 and 220 are set to be the active fields as a whole and the comparators 231˜238 of the comparing logic 230 are all activated. The active field size SI in the texture cache memory device 200 is summarized into N/2^{W}=8/2⁰=8/1=8. In this case, the power consumption goes to the maximum level. But the hit rate is improved because the texture cache memory device 200 is able to store the plurality of textures.

FIG. 4 illustrates active fields of the texture cache memory device 200 when the number of the textures input thereto is B. When the number of the textures is set on the second value B, the bit width W of the set in the memory address is set on 1-bit. When the memory address is composed of x bits and the offset address is composed of y bits, the tag address is formed of x-y-1 bits. Thus, the active field size SI in the texture cache memory device 200 is summarized into N/2^{W}=8/2¹=8/2=4. In this case, the texture cache memory device 200 operates as similar to a 4-way set-associative memory. FIG. 4 shows the case that the bit value SET of the set is fixed to ‘1’. Then, the comparators, 232, 234, 236, and 238, and the corresponding ways of the tag and data memories 210 and 220 are activated.

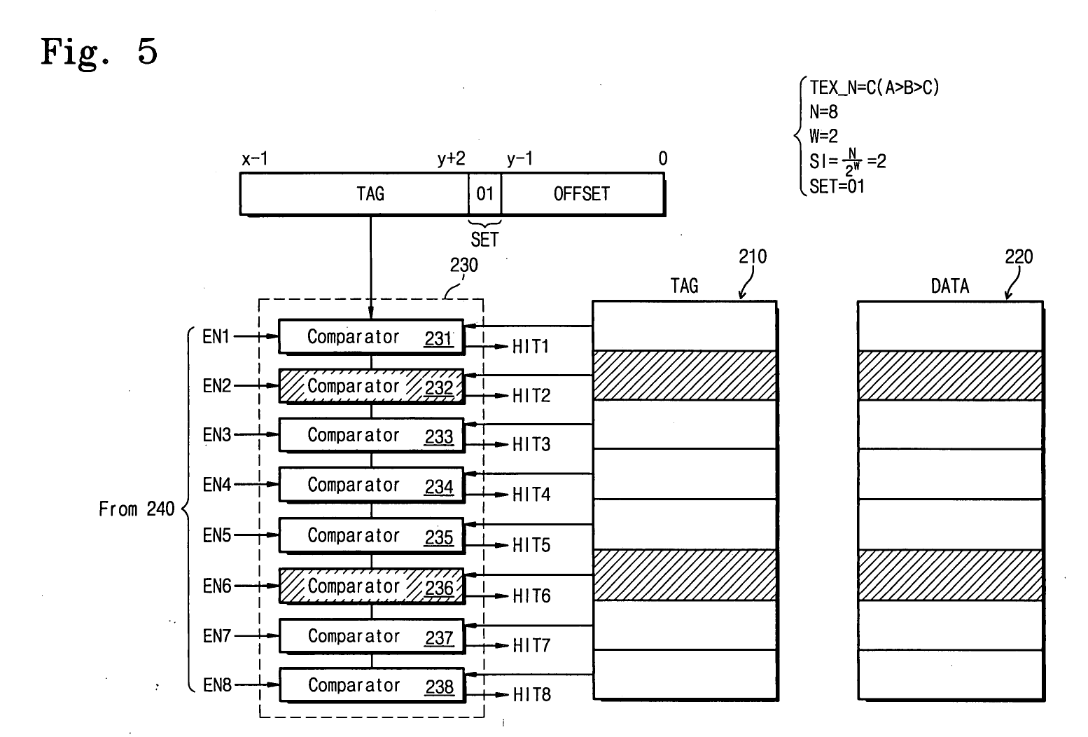

FIG. 5 illustrates active fields of the texture cache memory device 200 when the number of the textures input thereto is C. When the number of the textures is set on the third value C, the bit width W of the set in the memory address is set on 2-bit. When the memory address is composed of x bits and the offset address is composed of y bits, the tag address is formed of x-y-2 bits. Thus, the active field size SI in the texture cache memory device 200 is summarized into N/2^{W}=8/2²=8/4=2. In this case, the texture cache memory device 200 operates as similar to a 2-way set-associative memory. FIG. 5 shows the case that the bit value SET of the set is fixed to ‘01’. Then, the comparators, 232, and 236, and the corresponding ways of the tag and data memories 210 and 220 are activated.

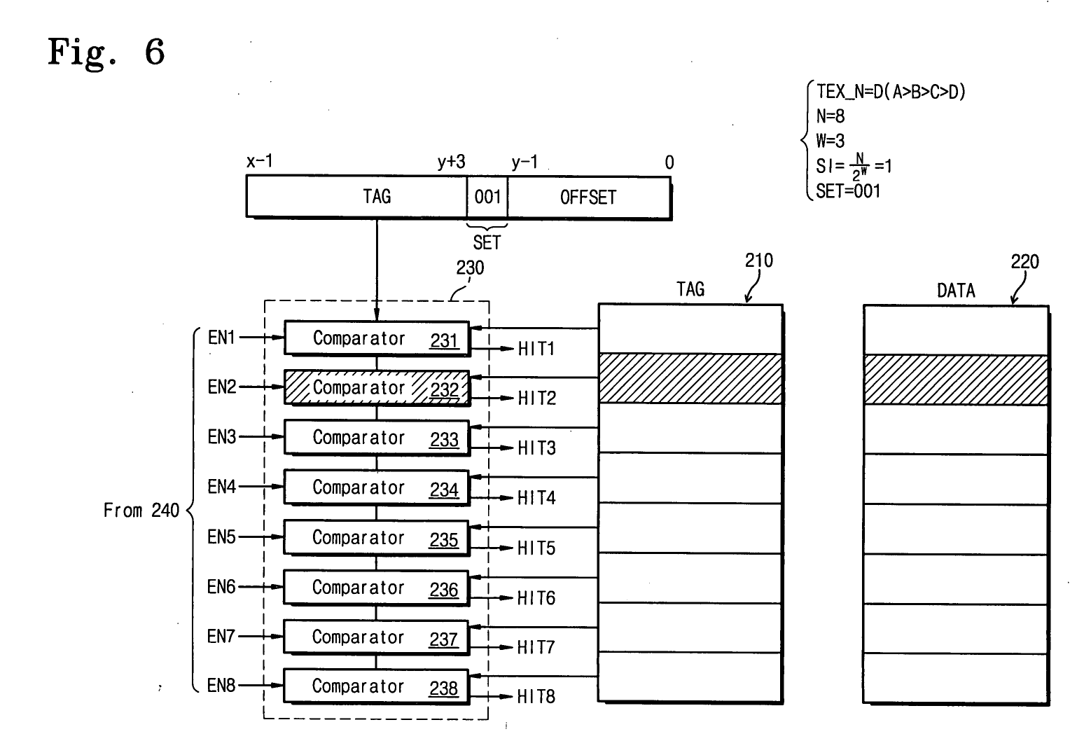

FIG. 6 illustrates active fields of the texture cache memory device 200 when the number of the textures input thereto is D. When the number of the textures is set on the fourth value D, the bit width W of the set of the memory address is set on 3-bit. When the memory address is composed of x bits and the offset address is composed of y bits, the tag address is formed of x-y-3 bits. Thus, the active field size SI in the texture cache memory device 200 is summarized into N/2^{W}=8/2³=8/8=1. In this case, the texture cache memory device 200 operates as similar to a 1-way set-associative memory. FIG. 6 shows the case that the bit value SET of the set is fixed to ‘001’. Then, the comparator 232 and the corresponding ways of the tag and data memories 210 and 220 are activated. The texture cache memory device conductive with 1-way is operable in lower power consumption rather than the others conductive with 8-way, 4-way, and 2-way. For instance, when the number of the textures is D=1, the cache hit rate does not lower even though the texture cache memory device 200 is operating with 1-way.

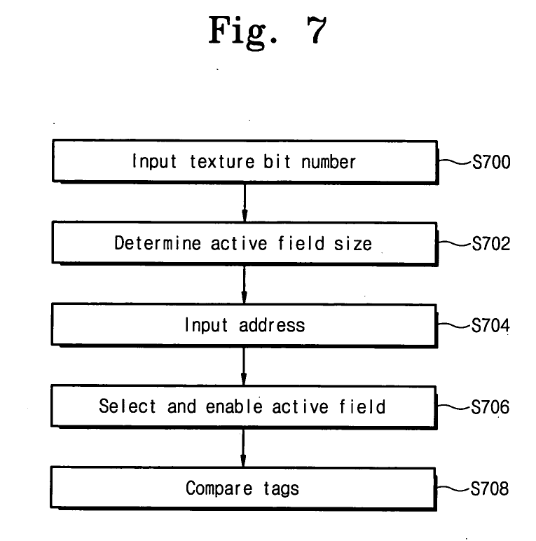

FIG. 7 is a flow chart showing an operational procedure of the texture cache memory device 200 in accordance with a preferred embodiment of the invention.

First, in step S700, the control logic 240 of the texture cache memory device 200 receives the information about the number of the textures TEX_N from the rasterizing unit 132.

Then, in step S702, it determines the active field size SI in accordance with the number of the textures TEX-N input thereto. The active field size SI is obtained by determining the bit width W of the set in the memory address. The active field size SI is defined by N/2^{W}=N/k. Thus, the texture cache memory device 200 operates with N/k ways.

Next, in step S704, the control logic 240 receives the memory address from the rasterizing address 132.

In step S706, the control logic 240 selects active fields in accordance with the bit value of the set in the memory address input thereto, and then makes the elected active fields conductive.

And, in step S708, the comparators activated in the comparing logic 230 make comparisons between a tag of the memory address input thereto and tags stored in the ways activated in the tag memory 210.

Afterward, the texture cache memory device 200 operates as same as a general cache memory. But, the active fields in the texture cache memory device 200 only prosecute effective operations. The active fields in the texture cache memory device 200 are maintained without changes until there is an input of the next number of the textures.

As described above, the invention is able to a size of the active field in the texture cache memory device in accordance with the number of the textures to be mapped onto an object. If the number of the textures is small, a proper hit rate is maintained even with a smaller size of the active field, reducing power consumption therein. Otherwise, the number of the textures is large, the size of the active field is enlarged to enhance the hit rate even in higher power consumption, decreasing loading weight while accessing a main memory. Thus, the texture cache memory device is operable with the optimum condition in accordance with the number of the textures.

While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein.

What is claimed is:

1. A method of operating a texture cache memory device, the method comprising the steps of:
inputting information of the number of textures; and
determining a size of an active field of the texture cache memory device in accordance with the number of the textures.

2. The method as set forth in claim 1, wherein the step of determining the size of the active field comprises: determining a bit width of a set in an address signal in accordance with the determined size of the active field.

3. The method as set forth in claim 2, which further comprises:
inputting the address signal; and
enabling the active field of the texture cache memory device with reference to a bit value of the set in the address signal.

4. The method as set forth in claim 3, wherein the texture cache memory device includes N regions.

5. The method as set forth in claim 4, wherein the step of determining the size of the active field comprises: establishing N/k (k≦N) regions, among the N regions of the texture cache memory device, as the active field.

6. The method as set forth in claim 1, wherein the textures are mapped on an object.

7. A method of operating an N-way texture cache memory device, the method comprising the steps of:
inputting information of the number of textures; and
selecting N/k (k≦N) ways as an active field with reference to the number of the textures.

8. The method as set forth in claim 7, which further comprises:
determining a bit width of a set in an address signal in accordance with the number of the selected ways;
inputting the address signal; and
enabling the active field of the texture cache memory device with reference to a bit value of the set in the address signal.

9. The method as set forth in claim 8, wherein the number of the textures is proportional to the number of the ways selected into the active field.

10. The method as set forth in claim 8, which further comprises: inactivating N-N/k ways of the texture cache memory device with reference to the bit value of the set in the address signal.

11. The method as set forth in claim 10, wherein the texture cache memory device includes an N-way tag memory storing a tag address and an N-way data memory storing data,
wherein the step of selection comprises:
assigning N/k ways among N ways of the tag memory and N/k ways among N ways of the data memory to the active field.

12. The method as set forth in claim 1 1, which further comprises:
comparing a tag of the address signal with tags stored in the N/k ways of the tag memory which are assigned to the active field.

13. The method as set forth in claim 11, wherein the texture cache memory device further includes N comparators each corresponding to N ways of the tag memory, comparing a tag of the address signal with tags stored in corresponding ways of the tag memory,
which further comprises:
activating N/k comparators, among the comparators, corresponding to the N/k ways of the tag memory which are assigned to the active field, in accordance with the number of the textures.

14. The method as set forth in claim 13, which further comprises:
inactivating the rest comparators except the N/k comparators selected in the comparators.

15. A texture cache memory device comprising:
a texture cache memory storing textures; and
a control logic receiving information of the number of textures and selecting a size of an active field in accordance with the number of the textures.

16. The texture cache memory device as set forth in claim 15, wherein the control logic receives an address signal and selects the active field of the texture cache memory in response to the address signal and the selected size.

17. The texture cache memory device as set forth in claim 16, wherein the texture cache memory includes N regions.

18. The texture cache memory device as set forth in claim 17, wherein the control logic assigns N/k regions (k≦N) among the N regions to the active field.

19. A texture cache memory device comprising:
a tag memory storing tags;
a data memory storing texture data;
N comparators corresponding to ways of the tag memory; and
a control logic activating N/k (k≦N) comparators among the N comparators in response to the number of textures and an address signal.

20. The texture cache memory device as set forth in claim 19, wherein the address signal includes a tag and a set.

21. The texture cache memory device as set forth in claim 20, wherein the control logic determines a bit width of the set in the address signal in accordance with the number of the textures and activates the N/k (k≦N) comparators among the N comparators in accordance with a bit value of the set in the address signal.

22. The texture cache memory device as set forth in claim 21, wherein each of the N/k (k≦N) comparators activated the N comparators makes a comparison between the tag of the address signal and a tag correspondingly stored in the tag memory.

23. The texture cache memory device as set forth in claim 22, wherein N-N/k comparators among the N comparators are inactivated.

24. A 3-dimensional graphic accelerator comprising:
a texture cache memory device storing texture data,
wherein the texture cache memory device comprises:
a tag memory storing tags;
a data memory storing texture data;
N comparators corresponding to ways of the tag memory; and
a control logic activating N/k (k≦N) comparators among the N comparators in response to the number of textures and an address signal.

25. The 3-dimensional graphic accelerator as set forth in claim 24, wherein the control logic determines a bit width of a set in the address signal in accordance with the number of the textures and activates the N/k (k≦N) comparators among the N comparators in response to a bit value of the set in the address signal.

26. The 3-dimensional graphic accelerator as set forth in claim 25, wherein each of the N/k (k≦N) comparators activated the N comparators makes a comparison between the tag of the address signal and a tag correspondingly stored in the tag memory.
